(19) United States
(12) Patent Application Publication
(10) Pub. No.: US 2011/0131257 A1
(43) Pub. Date: Jun. 2, 2011

(54) FILE MANAGEMENT DEVICE

(75) Inventor: Yutaka Yoshida, Matsumoto-shi (JP)

(73) Assignee: SEIKO EPSON CORPORATION, Shinjuku-ku (JP)

(21) Appl. No.: 12/958,349

(22) Filed: Dec. 1, 2010

(30) Foreign Application Priority Data
Dec. 2, 2009 (JP) 2009-274849

(51) Int. Cl. G06F 17/30

(52) U.S. Cl. 707/822; 707/E17.008

(57) ABSTRACT

An image quality correction process of an image file which is stored in a memory card is performed and the processed image is stored in the memory card. In addition, referents of the image file are changed from places storing bodies of the original files to places storing bodies of the processed files. In response to a file access instruction is received from a user PC, a cluster content (image file) of a cluster number designated by the memory card is transmitted. In this way, the image after the APF process is received only by accessing to the image which is stored in the memory card without special operations in the user PC side.

### CROSS REFERENCES TO RELATED APPLICATIONS

The entire disclosure of Japanese Patent Application No. 2009-274849, filed 2009 Dec. 2 is incorporated by reference herein.

### BACKGROUND

1. Technical Field

The present invention relates to a file management device.

2. Related Art

In the related art, as file management devices, there has been proposed one where object files are classified for each folder (for example, see JP-A-2008-269079). In this device, a folder configuration is created according to conditions designated by a user, and object files are classified based on the created folder configuration. Therefore, the files can be easily classified since the user's workloads are not large even when the number of files increases.

On the other hand, when a predetermined process is performed for files due to an instruction from a user and then the processed files are treated, for example, when a case where an image quality correction is performed for image files and the corrected image files are treated is considered, if the number of files increases, a user instructs a process for each file, and it is necessary for the user himself/herself to manage the processed files, and thus the user's operational burden becomes large.

### SUMMARY

An advantage of some aspects of the invention is to provide a file management device capable of accessing processed files having undergone a predetermined process without following settings performed by a user.

In order to achieve the advantage, the file management device has the following means.

A first file management device according to an aspect of the invention includes an obtaining unit that obtains original files from a storage device; a notification unit that sends a notification that process files corresponding to the original files exist at positions where the process files do not actually exist; a reception unit that receives an instruction for accessing the process files; and an access response unit that, when the access instruction is received, enables a processed file obtained after a predetermined process is performed for the original file corresponding to an object of the access instruction, to be accessed.

In the first file management device according to an aspect of the invention, a plurality of files is obtained from the storage device, the notification that files exist at positions where the files do not actually exist is sent, an instruction for accessing the files which are notified as existing in a storage unit is received, and when the access instruction is received, a processed file obtained by performing a predetermined process for a file corresponding to an object of the access instruction is accessed according to the access instruction. Therefore, it is possible to obtain the processed file having undergone a predetermined process without following settings by a user. Here, the storage device may be constituted by a single storage unit or a plurality of storage units. In the latter case, there may be a configuration where the storage device includes a first storage unit constituted by a memory card which is inserted into the file management device and a second storage unit constituted by a RAM provided in the file management device, a plurality of files is obtained from the first storage unit, files corresponding to the files in the first storage unit appear to exist in the second storage unit, an obtaining instruction corresponding to a file which appears to exist in the second storage unit, and when the obtaining instruction is received, a file corresponding to a file which is an object of the obtaining instruction is obtained from the first storage unit, and a processed file after a predetermined process is performed for the obtained file is supplied according to the obtaining instruction. In this case, the predetermined process may be a process for the files which appear to exist in the second storage unit.

A second file management device according to an aspect of the invention includes a file obtaining means that obtains files stored in a storage device; a file processing and storing means that stores processed files obtained by performing a predetermined process for the obtained files in the storage device and sends a notification that referents of files is changed from places storing bodies of the original files to places storing bodies of the processed files; and an access response means that makes a response when there is an access request for the files stored in the storage device, by obtaining a corresponding file body from the storage device based on a referent designated by the request.

In the second file management device according to an aspect of the invention, files stored in a storage device are obtained, processed files obtained by performing a predetermined process for the obtained files are stored in the storage device and a notification that referents of files is changed from places storing bodies of the original files to places storing bodies of the processed files is sent, and when there is an access request for the files stored in the storage device, a response is made by obtaining a corresponding file body from the storage device based on a referent designated by the request. Therefore, it is possible to easily obtain the processed files without activating special operations or applications in an accessing side.

In the file management device which processes image files as the files, the file processing and storing means may be a means which performs an image quality correction process or a magnification change process as the predetermined process for the image files for storage.

In the file management device, the storage device may be a device which manages data using directory entries, and the file processing and storing means creates directory entries which designate referents of processed files as places storing bodies of the processed files, in the directory entries of the storage device. Thereby, it is possible to more easily obtain the processed files using the directory entries.

Also, the invention is applicable to a file management method and a storage medium storing a file management program, as well as the file management device.

### BRIEF DESCRIPTION OF THE DRAWINGS

The invention will be described with reference to the accompanying drawings, wherein like numbers reference like elements.

FIG. 1 is a configuration diagram of a printing system according to an embodiment of the invention.

FIG. 2 is an explanatory diagram illustrating an example of a folder configuration in a memory card.

FIG. 3 is a flowchart illustrating an example of an APF drive creation process.

FIG. 4 is an explanatory diagram illustrating an example of a cluster configuration of image files in the memory card.

FIG. 5 is an explanatory diagram illustrating an example of a cluster configuration of image files after an APF process.

FIG. 6 is an explanatory diagram illustrating an example of a directory entry.

FIG. 7 is a flowchart illustrating an example of an access response process.

### DESCRIPTION OF EXEMPLARY EMBODIMENTS

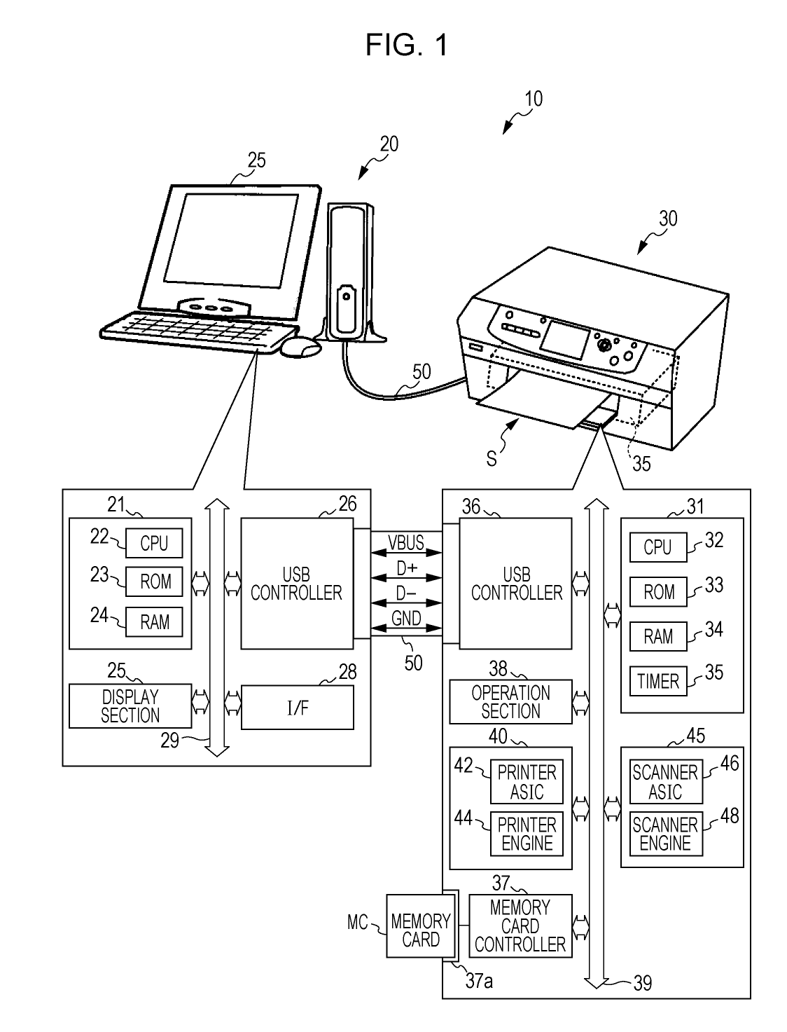

Next, a first embodiment of the invention will be described with reference to the accompanying drawings. FIG. 1 is a schematic configuration diagram illustrating a configuration of a printing system 10 according to the first embodiment of the invention. The printing system 10 in this embodiment includes, as shown in the figure, a user computer (hereinafter, referred to as a user PC) 20 and a printer 30, which are connected to each other via a USB cable 50.

The printer 30 is provided with a main controller 31 which controls the entire device, a printer unit 40 which performs printing by ejecting ink which is a colorant on recording paper S, a scanner unit 45 which optically reads a copy placed on a copy holder and generates image data, a memory card controller 37 which inputs and outputs data to and from a memory card MC inserted into a memory card slot 37a, and an operation section 38 which is constituted by a power button, a mode selection button for selecting operation modes, a start button, and so on. The above-described elements are electrically connected to each other via a bus 39. The operation modes which can be selected using the mode selection button include a scan mode where a copy placed on the copy holder is read, a copying mode where a copy placed on the copy holder is read and then is printed, a memory card mode where image data stored in the memory card MC is read and then is printed, and so on.

The printer unit 40 has a printer ASIC 42 and a printer engine 44. The printer ASIC 42 is an integrated circuit controlling the printer engine 44, and controls the printer engine 44 to perform printing on paper based on an image file which is an object of a printing command, if receiving the printing command from a main controller 31. The printer engine 44 is constituted by a well-known ink jet type color printer mechanism which performs printing by ejecting ink on paper from a printing head. Here, ASIC stands for Application Specific Integrated Circuit.

The scanner unit 45 has a scanner ASIC 46 and a scanner engine 48. The scanner ASIC 46 is an integrated circuit controlling the scanner engine 48, and controls the scanner engine 48 to read a copy placed on the copy holder as image data, if receiving a scanning command from the main controller 31. Also, the scanner engine 48 is constituted by a well-known image scanner, and is provided with a well-known color image sensor which emits light towards a copy, decomposes light reflected therefrom into the respective colors of red (R), green (G), and blue (B) so as to obtain scanning data.

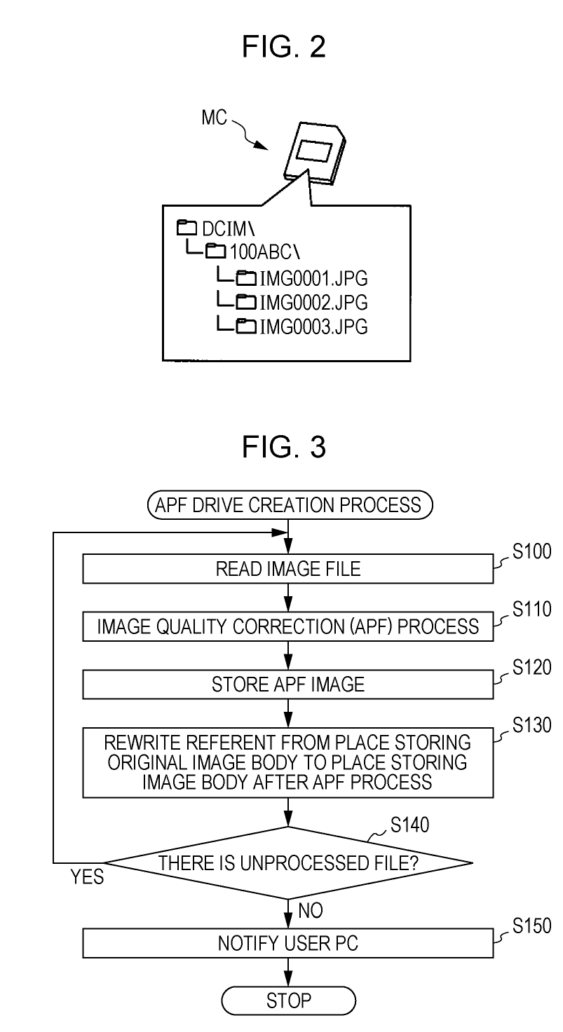

The memory card controller 37 exchanges data with the memory card MC inserted into the memory card slot 37a, and thereby reads files stored in the memory card MC and transmits them to the main controller 31, or writes data in the memory card MC in response to a command from the main controller 31. FIG. 2 shows an example of a folder configuration of image files stored in the memory card MC. In the folder configuration in the memory card MC, as shown in the figure, a folder “DCIM” indicating images taken by a digital camera stores a folder “100ABC” indicating a manufacturer of the photographing digital camera, and the folder “100ABC” stores image files “IMG0001.JPG,” “IMG0002.JPG,” and “IMG0003.JPG.” In this embodiment, the image files “IMG0001.JPG,” “IMG0002.JPG,” and “IMG0003.JPG” are stored in an Exif (Exchangeable Image File) format, and include additional information such as photographing date, or a model name and a manufacturer name of the photographing digital camera.

A USB controller 36, of which a connection terminal 36a is connected to the USB cable 50, is a controller which controls exchanging of data with the user PC 20 via the USB cable 50. In addition, the connection terminal 36a is constituted by a standard B receptacle which can connect two power system lines of a VBUS line and a GND line to two signal system lines of a D+ line and a D− line.

The main controller 31 is constituted by a microprocessor centering on a CPU 32, and includes a ROM 33 storing various kinds of processing programs, a RAM 34 temporarily storing data, and a timer 35 counting a polling time. The RAM 34 is provided with a reception buffer which stores commands output from the user PC 20. The main controller 31 receives commands from the user PC 20 by performing a polling process where it is repeatedly confirmed every predetermined time whether or not the commands are stored in the reception buffer.

The user PC 20 is a general personal computer having a controller 21, a display section 25 as a display, a USB controller 26, and an interface (I/F) 28, and transmits various kinds of commands to the printer 30 or receives responses from the printer 30, by a program (printer driver) installed in a HDD (not shown). The various kinds of commands transmitted to the printer 30 include not only the printing command for performing printing but also a file access command for accessing files stored in the memory card MC installed in the memory card slot 37a of the printer 30. The USB controller 26, of which a connection terminal 26a is connected to the USB cable 50, is a controller which controls exchanging data with the printer 30 via the USB cable 50. In addition, the connection terminal 26a is constituted by a standard A receptacle which can connect two power system lines of a VBUS line and a GND line to two signal system lines of a D+ line and a D− line.

Next, an operation of the printer 30 in this embodiment configured in this way, particularly, an operation when the user PC 20 accesses the memory card MC of the printer 30 will be described. FIG. 3 is a flowchart illustrating an example of an APF drive creation process performed by the main controller 31 of the printer 30. This routine is executed when the memory card MC is inserted into the memory card slot 37a of the printer 30.

If the APF drive creation process is performed, first, the CPU 32 of the main controller 31 reads image files stored in the memory card MC via the memory card controller 37 (step S100), performs an image quality correction process (an APF process) for the read image files (step S110), and stores the image files having undergone the APF process in an unused region of the memory card MC (step S120). The CPU 32 correlates information specifying a file such as a file name in a file system with a cluster number or a pointer indicating a position where an entity of the file exists, thereby setting a director entry which is data used to refer to the entity of the file such that a referent of an image file becomes a place storing the image file body after the APF process which is newly stored in the memory card MC instead of a place storing the original file stored in the memory card MC (step S130). Further, the CPU 32 determines whether or not there are unprocessed image files of the image files stored in the memory card MC (step S140), and if there are unprocessed files, the workflow returns to step S100 and then steps S100 to S130 are repeated. If there are no unprocessed image files, the CPU 32 notifies the user PC 20 of information specifying a directory or a file (step S150) and finishes the current process.

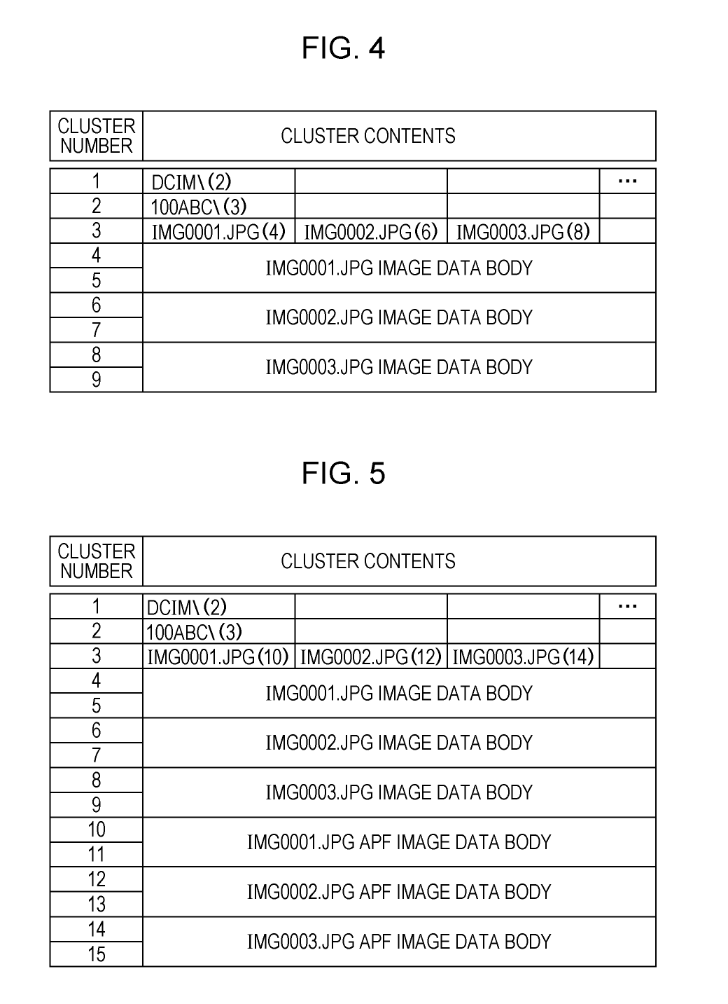

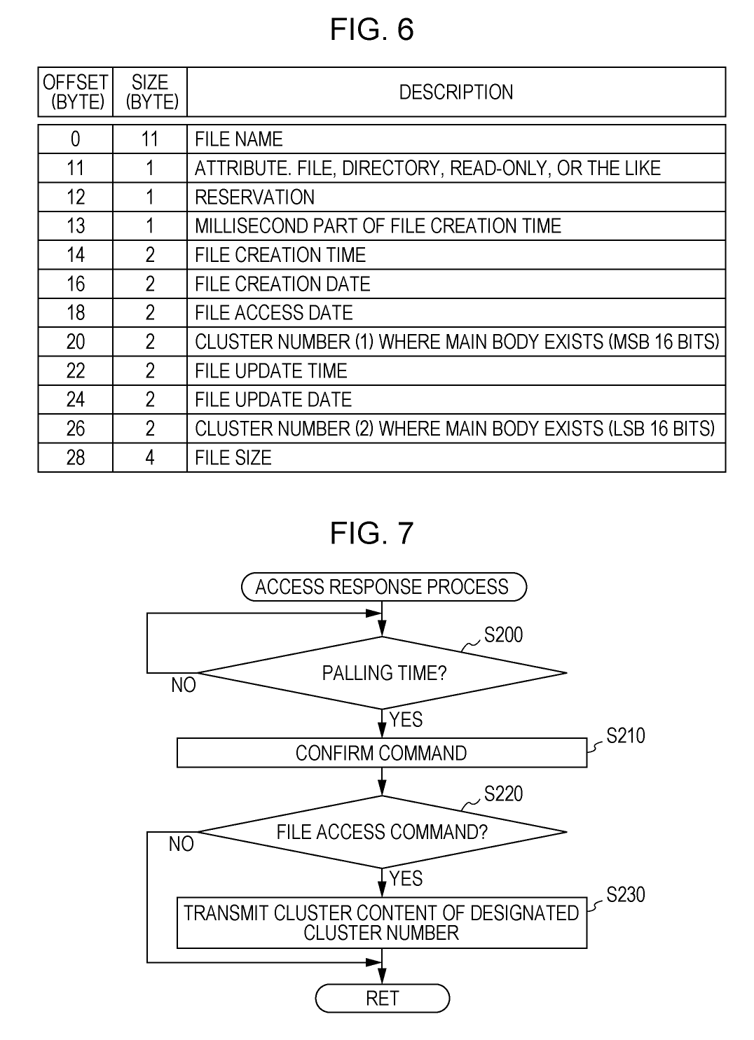

FIG. 4 shows an example of a cluster configuration for the image files stored in the memory card MC, and FIG. 5 shows an example of a cluster configuration for the image files created on the RAM 34. “DCIM¥(2),” “100ABC¥(3),” “IMG0001.JPG(4),” “IMG0002.JPG(6),” and “IMG0003.JPG(8)” in FIG. 4, and “DCIM¥(2),” “100ABC¥(3),” “IMG0001.JPG(10),” “IMG0002.JPG(12),” and “IMG0003.JPG(14)” in FIG. 5 denote directory entries, and the numbers in the parentheses denote cluster numbers of referents. FIG. 6 shows a configuration of directory entries. As shown in the figure, the directory entries include a file name, attribute, reservation, file creation time (millisecond part), file creation time, file creation date, file access date, a cluster number where file body exists (MSB 16 bits), file update date, a cluster number where a file body exists (LSB 16 bits), a file size, and the like. As shown in FIGS. 4 and 5, if the APF drive creation process is performed, an APF image data body of the file IMG0001.JPG, an APF image data body of the file IMG0002.JPG, and an APF image data of the file IMG0003.JPG are added on the memory card MC, and the referents of the files “IMG0001.JPG,” “IMG0002.JPG,” and “IMG0003.JPG” are respectively rewritten from the places storing the original image data bodies (the respective cluster numbers 4, 6, 8) to the places storing the image data bodies after the APF process (the respective cluster numbers 10, 12, 14).

FIG. 7 is a flowchart illustrating an example of an access response process performed by the main controller 31. This process is performed when the main controller 31 receives the access command from the user PC 20. In the access response process, first, the main controller 31 waits for a polling time to elapse (step S200), and confirms whether or not a command is stored in the reception buffer of the RAM 34 (step S210). When the file access command is not stored, it is determined that other process commands are not received, and then the access response process is finished. When commands other than the file access command are stored, processes based on the commands start. On the other hand, when the file access command is stored in the reception buffer of the RAM 34, a cluster content of a cluster number designated by the file access command or a cluster content of a referent cluster number of a commanded file in the memory card MC is transmitted (step S230), and the current process is finished. Now, a case where the cluster configuration in FIG. 5 is created from the cluster configuration in FIG. 4 by the APF drive creation process will be considered. In this case, since the respective referents of the files IMG0001.JPG, IMG0002.JPG, and IMG0003.JPG are not the respective cluster numbers 4, 6 and 8 which are the place storing the original image bodies but the respective cluster numbers 10, 12 and 14 which are the places storing the image bodies after the APF process, for example, when the user PC 20 side designates the cluster number 10 so as to instruct the file “IMG0001.JPG” to be read, the image after the APF process is read and is transmitted to the user PC 20 side. Therefore, the user PC 20 side can receive the image after the APF process simply by intending to access the images stored in the memory card MC without activating special operations or applications.

Here, correspondence relationships between the constituent elements in this embodiment and constituent elements of the invention are exhibited. The memory card controller 37 and the main controller 21 in this embodiment performing the process at step S100 in the APF drive creation process in FIG. 3 correspond to a “file obtaining means” of the invention, the main controller 21 performing the processes at steps S110 to S140 in the APF drive creation process in FIG. 3 in this embodiment corresponds to a “file processing and storing means” of the invention, and the main controller 21 performing the access response process in FIG. 7 in this embodiment corresponds to an “access response means” of the invention.

According to the printer 30 in this embodiment described above, the image quality correction (APF) process is performed for the image files stored in the memory card MC, the images after the APF process are stored in the memory card MC, and the referents of the image files are rewritten from the storing places (cluster numbers) of the original image data bodies to the storing places (cluster numbers) of the image data bodies after the APF process. When the file access command is received from the user PC 20, a cluster content (image file) of a designated cluster number is transmitted from the memory card MC. Therefore, it is possible to easily obtain the images after the APF process simply by intending to access the images stored in the memory card MC without special operations in the user PC 20 side.

Next, a second embodiment of the invention will be described. Although the APF process is performed when the memory card MC is inserted into the memory card slot 37a of the printer 30 in the first embodiment, in the second embodiment, the APF process is not performed when the memory card MC is inserted, an APF folder is created on directory entries, files the same as original files are prepared on directory entries in the APF folder, and then a notification thereof is sent to the user PC 20. When a command for access to the files in the APF folder is received from the user PC 20, the APF process is performed for a corresponding file, and after the APF process the file is transmitted to the user PC 20. The remainders are the same as in the first embodiment. In this way, since the APF process is not performed for all of the files, it is possible to save time, and since there is no need to store all data for the files after the APF process, it is possible to save the size of the memory card MC having limitation in a storage capacity.

Although the files after the APF process are stored in the unused region of the memory card MC in the first embodiment, the files may be stored in the RAM 34. In this case, there may be a configuration where the files after the APF process are stored in the RAM 34, then directory entries are prepared on the RAM 34, referents of image files in an original folder are designated as storing places of original file bodies stored in the memory card MC, files having the same names as the original files are prepared in a new folder named “APF.” Also, referents of the files may be designated as storing places of image files after the APF process on the RAM 34, and a notification thereof may be sent to the user PC 20.

Although the APF process is performed for the image files in the first and second embodiments of the invention, the APF process may be performed, for example, for any files such as documents, voices, moving images, as long as a predetermined process is performed for appropriate files. Further, the process used is not limited to the APF process, but any processes such as a magnification changing process which changes magnification of images or a conversion process which converts file formats may be used. In the case of using the magnification changing process or the conversion process, the APF process at step S110 in FIG. 3 may be replaced with the magnification changing process or the conversion process. Also, a user may select a process to be used. For example, there may be preparations of a folder for each process (for example, an “APF” folder corresponding to the APF process, an “a-tenth” folder corresponding to the magnification changing process which reduces magnification of files to a-tenth, or the like) and files having the same names as original files in each folder on directory entries, and a process corresponding to the folder where a designated file is positioned may be performed for appropriate files. In addition, there may be preparations of files having names corresponding to the respective processes in the same folder (for example, “APF IMG0001.JPG” corresponding to the APF process, “A-TENTH IMG0001.JPG” corresponding to the magnification changing process which reduces magnification of files to a-tenth, or the like) on directory entries, and a process corresponding to a designated file may be performed for appropriate files.

Although the printer is constituted by a multifunctioning printer which is provided with the printer unit 40 and the scanner unit 45 in this embodiment, only the printer unit 40 may be provided or only the scanner unit 45 may be provided. The file management device according to the embodiments of the invention is not limited to a printer or a scanner but may be applied to other appropriate devices such as a facsimile, a viewer, or a memory card reader.

It is to be understood that the invention is not limited to the above-described embodiments, but is intended to cover various modifications, equivalent arrangements or alternatives included within the spirit and scope of the present invention.

What is claimed is:

1. A file management device which manages files, comprising:
an obtaining unit that obtains original files from a storage device;
a notification unit that sends a notification that process files corresponding to the original files exist at positions where the process files do not actually exist;
a reception unit that receives an instruction for accessing the process files; and
an access response unit that, in response to the access instruction is received, enables a processed file obtained after a predetermined process is performed for the original file corresponding to an object of the access instruction, to be accessed.

2. The file management device according to claim 1, further comprising a file processing and storing unit that stores processed files obtained by performing a predetermined process for the original files before the access instruction is received, in a predetermined storage section,
wherein the access response unit enables a processed file, which is obtained after a predetermined process is performed for the original file corresponding to an object of the access instruction and which is stored in the storage section, to be accessed.

3. The file management device according to claim 1, wherein the access response unit performs the predetermined process for the original file corresponding to an object of the access instruction after the access instruction is received, to thereby generate the processed file, and enables the generated processed file to be accessed.

4. The file management device according to claim 1, wherein the file management device processes image files as the files, and
wherein the predetermined process is an image quality correction process or a magnification changing process which is performed for the image files.

5. The file management device according to claim 1, wherein the notification unit sends a notification of process files for each of a plurality of processes, and
wherein the access response unit enables a processed file having undergone a process corresponding to an object of the access instruction to be accessed.

6. The file management device according to claim 1, wherein the file management device is also the storage device.

7. The file management device according to claim 2, wherein the file management device processes image files as the original files, and
wherein the predetermined process is an image quality correction process or a magnification changing process which is performed for the image files.

8. The file management device according to claim 2, wherein the storage device is a device which manages data using directory entries, and
wherein the file processing and storing unit creates directory entries which designate referents of processed files as places storing bodies of the processed files, in the directory entries of the storage device.

9. The file management device according to claim 2, wherein the file management device is also the storage device.

10. The file management device according to claim 3, wherein the file management device processes image files as the original files, and
wherein the predetermined process is an image quality correction process or a magnification changing process which is performed for the image files.

11. A file management method which manages files, comprising:
obtaining original files from a storage device;
sending a notification that process files corresponding to the original files exist at positions where the process files do not actually exist;
receiving an instruction for accessing the process files; and
enabling a processed file obtained after a predetermined process is performed for the original file corresponding to an object of the access instruction, to be accessed in response to the access instruction is received.

12. The file management method according to claim 11, further comprising storing processed files obtained by performing a predetermined process for the original files before the access instruction is received, in a predetermined storage section,
wherein in the access response step, a processed file is accessed, which is obtained after a predetermined process is performed for the original file corresponding to an object of the access instruction and which is stored in the storage section.

13. The file management method according to claim 11, wherein in the access response step, the predetermined process is performed for the original file corresponding to an object of the access instruction after the access instruction is received, to thereby generate the processed file, and the generated processed file is accessed.

14. A non-transitory storage medium storing a file management program which manages files therein, the file management program enabling a computer to perform:
obtaining original files from a storage device;
sending a notification that process files corresponding to the original files exist at positions where the process files do not actually exist;
receiving an instruction for accessing the process files; and
enabling a processed file obtained after a predetermined process is performed for the original file corresponding to an object of the access instruction, to be accessed in response to the access instruction is received.

15. The storage medium according to claim 14, the file management program enabling a computer to further perform:
storing processed files obtained by performing a predetermined process for the original files before the access instruction is received, in a predetermined storage section,
wherein in the access response step, a processed file is accessed, which is obtained after a predetermined process is performed for the original file corresponding to an object of the access instruction and which is stored in the storage section.

16. The storage medium according to claim 14, wherein in the access response step, the predetermined process is performed for the original file corresponding to an object of the access instruction after the access instruction is received, to thereby generate the processed file, and the generated processed file is accessed.
